(19) United States
(12) Patent Application Publication
(10) Pub. No.: US 2008/0060416 A1
(43) Pub. Date: Mar. 13, 2008

(54) Measuring Device and a Method for Measuring the Thickness of a Layer of a Moving Strip

(75) Inventor: Bengt Akerblom, Varby (SE)

Correspondence Address: BUCHANAN, INGERSOLL & ROONEY PC, POST OFFICE BOX 1404, ALEXANDRIA, VA, 22313-1404, US

(73) Assignee: DAPROX AB, Skarholmen (SE)

(21) Appl. No.: 11/597,277

(22) PCT Filed: May 20, 2005
(86) PCT No.: PCT/SE05/00750

§ 371 Date: Nov. 21, 2006

(30) Foreign Application Priority Data
May 28, 2004 (SE) 0401372-8

(51) Int. Cl. G01B 13/06; G01B 7/06

(52) U.S. Cl. 73/37.6; 324/230

(57) ABSTRACT

The present invention relates to a measuring device and a method for measuring the thickness of at least one layer of a moving strip. The measuring device comprises a transmitter body, which is axially movable within a transmitter housing and has a sensor head, projecting from the transmitter housing and designed to rest against the layer via a gas cushion, and an upper portion, extending into a chamber delimited within the transmitter housing. The transmitter housing is provided with at least one port for the supply of gas, which, in part, forms the said gas cushion and, in part, flows into the chamber. The measuring device is characterized in that the transmitter housing is provided with a restrictor for evacuating gas from the chamber. The method comprises the step of measuring the thickness of the layer by means of a measuring device, the restrictor being adjusted in such a way that the gas cushion exerts a pressure against the layer equivalent to a weight of 0-65 g/cm2.

### TECHNICAL FIELD

The present invention relates to a measuring device and a method for measuring the thickness of a layer of a moving strip according to the preamble to claims 1 and 5 respectively.

### BACKGROUND ART

In the production of material in strips, such as paper or sheet-metal, which runs over rollers, it is desirable to be able to measure the thickness of the said strips or of a layer thereof, for example of paint or film, in order to be able to control the production in various respects.

To this end, it is known to use a type of measuring equipment in which a transmitter, movably mounted in a transmitter housing, is kept at a certain distance from a measured object by means of gas which is blown out between the transmitter and the strip and forms a gas cushion between them. With the aid of such a gas cushion, the gap between the transmitter and the measured object can be kept small and constant, which is beneficial to the measuring accuracy, without the transmitter hitting against the strip, which might cause damage to both the strip and the measuring device. It is also important for the measuring accuracy that the transmitter is easily movable within the transmitter housing, which is normally fixedly mounted. This is preferably achieved by gas-mounting of the transmitter in the transmitter housing, whereby the position of the transmitter can be adjusted to the particular thickness of the measured object.

A measuring device according to the above is known, for example, from Swedish patent SE 515 644.

A thickness measurement of the strip or layer by means of a measuring device according to the above suffers from a considerable drawback, however, since the pressure exerted upon the strip by the gas cushion tends to produce unwanted deformations of the said strip. Just such a deformed strip 2 is shown in FIG. 1, in which a portion 2a of the strip has been pressed against a roller 3 in the position before a diagrammatically shown measuring device 11. The result of these deformations is impaired accuracy of the measurement results and false values for the thickness of the strip or layer.

### OBJECT OF THE INVENTION

The object of the present invention is to provide a measuring device which produces minimal deformations of the object whose thickness is to be measured.

### DISCLOSURE OF INVENTION

The object of the present invention is achieved by means of a measuring device according to claim 1 and a method according to claim 5.

Claim 1 describes a measuring device for measuring the thickness of at least one layer of a moving strip, comprising a transmitter body, which is axially movable within a transmitter housing and has a sensor head, designed to rest against the layer via a gas cushion, and an upper portion, extending into a chamber delimited within the transmitter housing. The transmitter housing is provided with at least one port for the supply of gas, which flows, in part, through a longitudinal duct in the transmitter body so as to form the said gas cushion and flows, in part, into the chamber. The measuring device is characterized in that the transmitter housing is provided with a restrictor for evacuating gas from the chamber.

By maneuvering the restrictor, it is possible to regulate the gas pressure in the chamber. Since the pressure in the chamber acts directly upon the upper portion of the transmitter body, a regulation of the force exerted upon the transmitter head in the direction of the strip is also thereby achieved and the gas pressure is expediently adjusted in such a way that the pressure required in the gas cushion for separating the sensor head and the strip is minimized. The minimization of the pressure exerted upon the strip by the gas cushion solves the problem of strip deformations during measurement stemming from this pressure, which produces truer measurement results.

It is advantageous if the restrictor is manually controllable, since it hereby becomes possible to dispense with dear and complicated equipment for controlling the said restrictor. This is especially the case where a single adjustment of the restrictor prior to a thickness measurement is deemed sufficient.

The measuring device advantageously comprises a pressure sensor for determining the pressure in the gas cushion. Such a pressure sensor is expediently placed in the chamber to measure the pressure therein, which measurement values, through a known relationship, are used in determining the pressure in the gas cushion.

In certain cases, it can also be advantageous if the measuring device comprises at least one computer member for calculating the pressure acting against the layer via the gas cushion, on the basis of the pressure in the chamber determined by means of the pressure sensor, and for automatically controlling the restrictor in dependence on the calculated pressure against the gas cushion, since a continuous control ensures that the pressure against the strip is not varied over time.

Claim 5 describes a method for measuring the thickness of at least one layer of a moving strip, comprising the step of measuring the thickness of the layer by means of a measuring device comprising a transmitter body, which is axially movable within a transmitter housing and has a sensor head, designed to rest against the layer via a gas cushion, and an upper portion, extending into a chamber delimited within the transmitter housing. The transmitter housing is provided with at least one port for the supply of gas, which flows, in part, through a longitudinal duct in the transmitter body so as to form the said gas cushion and flows, in part, into the chamber. The method is characterized by the step that a restrictor, leading to the chamber, for evacuating gas from the chamber is adjusted prior to a thickness measurement of the layer in such a way that the gas cushion exerts a pressure against the layer equivalent to a weight of 0-65 g/cm². Deformations of the strip according to the above are thereby eliminated and truer measurement results are therefore acquired.

As has been mentioned above, it is advantageous if a computer member automatically and continuously calculates the pressure acting against the layer via the gas cushion, on the basis of a pressure in the chamber determined by means of a pressure sensor, and controls the restrictor in dependence on the calculated pressure against the layer in such a way that the gas cushion continuously exerts a pressure against the layer equivalent to a weight of about 0-65 g/cm².

### BRIEF DESCRIPTION OF DRAWINGS

The invention will now be described with reference to the appended figures, in which:

FIG. 1 shows how a strip is deformed in the use of a measuring device according to the prior art;

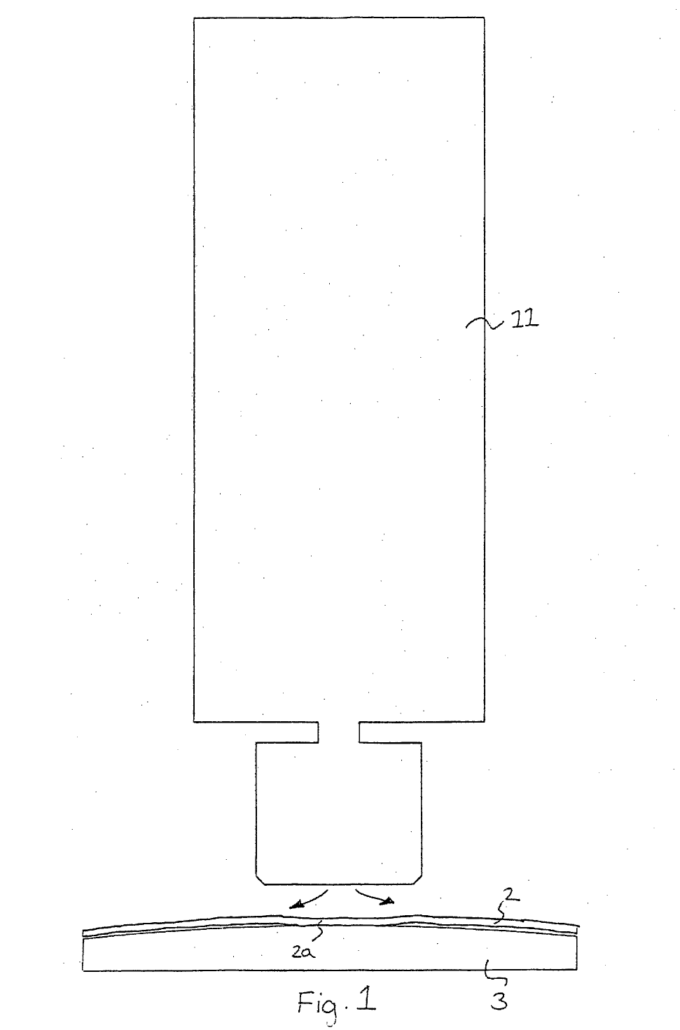

FIG. 2 shows a diagrammatic cross section through a measuring device according to a preferred embodiment of the present invention;

FIG. 3 shows a diagrammatic cross section along the line A-A in FIG. 2; and

FIG. 4 shows the air flow through the measuring device according to FIG. 2.

### MODE(S) FOR CARRYING OUT THE INVENTION

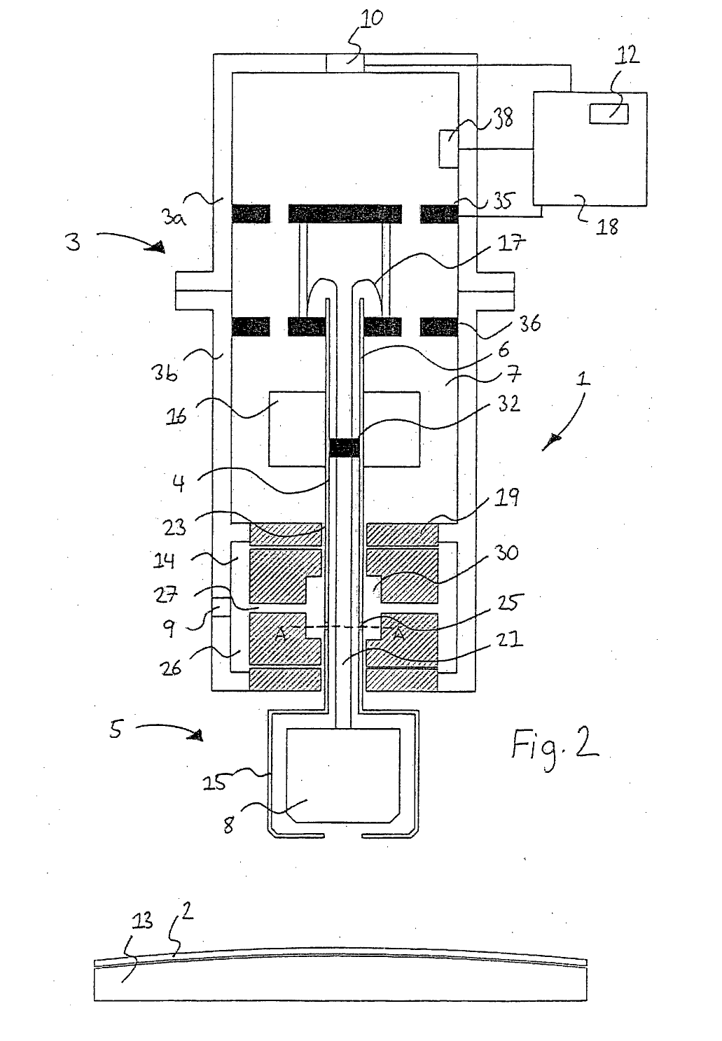

FIG. 2 shows a measuring device 1 according to the invention, positioned above a strip 2 of suitable material, such as paper or sheet-metal, for measuring the thickness of the strip 2 (alternatively the thickness of a layer in the strip, such as a coat of paint on a sheet-metal base). The strip 2 is supported by a support member 13, for example a roller in a production plant for the said strip 2.

The measuring device 1 comprises a transmitter body 4, which is gas-mounted in a transmitter housing 3 and is axially movable and has a sensor head 5 projecting from the transmitter housing 3, which sensor head 5, in turn, comprises a sensor 8 gas-mounted in a sensor housing 15. The sensor 8 is connected by a wiring arrangement 17 through the transmitter body 4 in a known manner to a measuring system 18 for handling measurement signals from the said sensor 8, and operates according to the reluctance principle or in some other way (for a closer description of the reluctance principle, refer to American patent U.S. Pat. No. 4,387,339).

The transmitter housing 3 consists of two housing parts joined tightly together, namely an upper housing part 3a and a lower housing part 3b, which together delimit a chamber 7. The lower housing part 3b also delimits an antechamber 14, in which a control part 19 is tightly accommodated, through which control part 19 an upper portion 6 of the transmitter body 4 runs in the form of a tubular shaft, from the sensor head 5 and into the chamber 7. In the chamber 7 a fixing body 16 is mounted on the shaft 6, which fixing body 16, above all, is intended in a known manner, by means of rod-shaped control elements (not shown), to prevent rotation of the transmitter body 6 relative to the transmitter housing 3 (for a closer description of these control elements and their working, refer to Swedish patent SE 515 644).

As can be seen from FIG. 2, the control part 19 is provided with a central vent 23 for the reception and gas-mounting of the shaft 6. From this vent 23, a number of radial ducts 27 emerge into a space 26 between a shell surface of the control part 19 and the lower housing part 3b, intended to conduct gas, for example air, from the space 26, supplied via a port 9 in the lower housing part 3b, to the vent 23. In the vent, the gas can then flow through openings 25 made in the shaft 6 to a duct 21 running through the shaft.

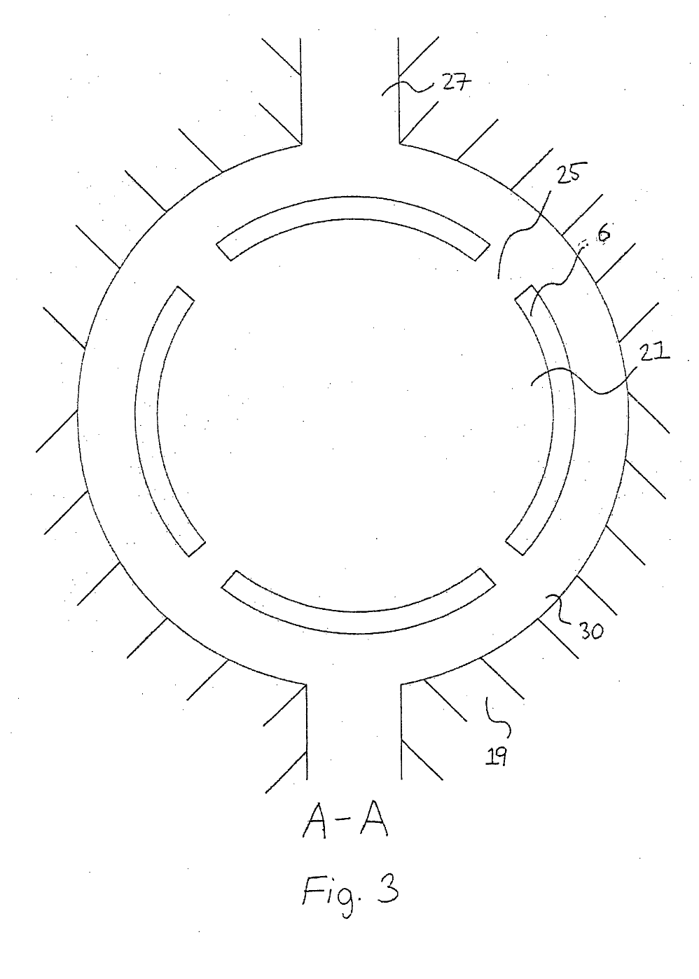

As can be seen from FIGS. 2 and 3, the shaft 6 is positioned in the vent 23 such that the openings 25 are situated in a portion thereof of larger diameter, forming an inner space 30 in the control part 19. The advantage with such an arrangement is that the greater volume of the inner space 30 ensures good pressure equalization therein, even when the measuring device 1 is tilted, thereby producing a predictable, even flow of gas into the shaft 6. To the same end, it is further advantageous if the openings 25 in the shaft 6 are not positioned directly in front of the radial ducts 27, they can equally, for example, be angled relative to the latter, as shown in FIG. 3, thereby ensuring a pressure equalization for the gas prior to flowing into the shaft 6.

Tightly accommodated in the duct 21 in the shaft 6 is a plug 32 for preventing gas from flowing into the chamber 7 via the duct 21, which plug, in a gas-tight manner, surrounds the wiring arrangement 17 running through it. In FIG. 2, the plug 32 is present within the fixing body 16, but it can also be fixed in other positions in the duct 21 above the openings 25.

Also present in the chamber 7 is an upper contact element 35, which is mounted in the upper housing part 3a and can be coupled together with a lower contact element 36, which is mounted in the lower housing part 3b and is connected by the wiring arrangement 17 to the sensor 8. The upper housing part 3a can thereby be removed from the lower housing part 3b, upon requirement, without damage to the wiring arrangement 17. As can be seen from FIG. 2, both the upper and the lower contact element are provided with vents for the through-flow of gas.

Finally, the transmitter housing 3 contains a restrictor 10, for example a throttle valve, which is intended to conduct gas out from the chamber 7 to the atmosphere surrounding the measuring device 1. The restrictor 10 in FIG. 2 is automatically controllable, in a manner to be described in further detail below, by means of a computer member 12 belonging to the measuring system 18, but might be manually controllable in another embodiment. In the chamber 7 there is also mounted a pressure sensor 38, it, too, connected to the computer member 12, for registering the pressure in the chamber 7.

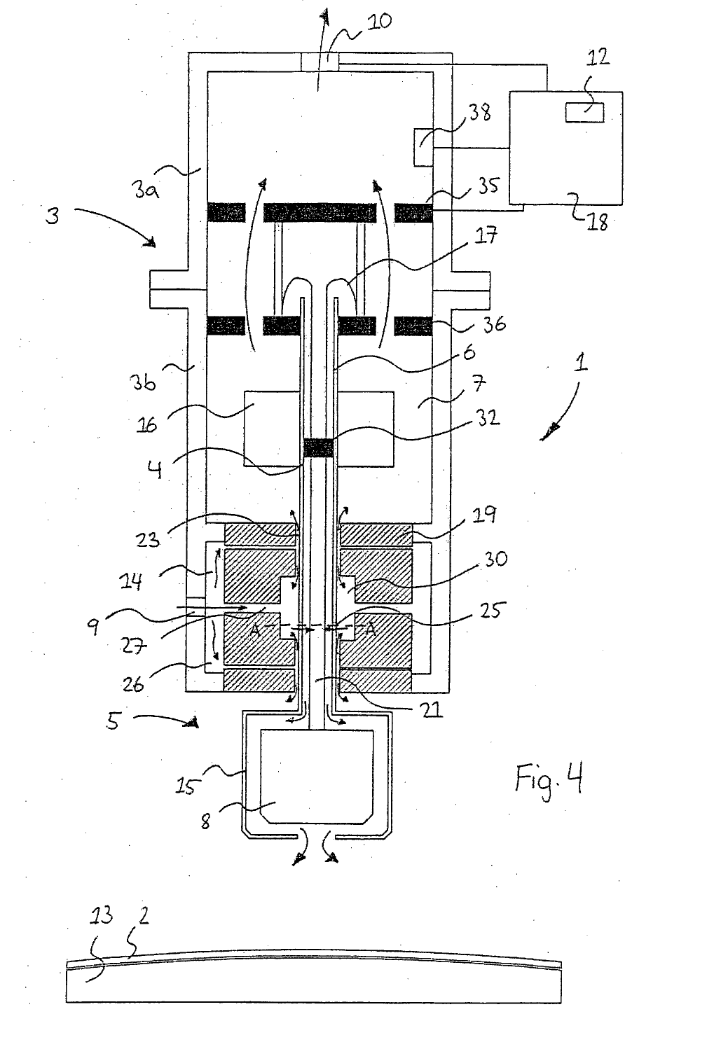

FIG. 4 shows, by means of unnumbered arrows, how the gas flows through the measuring device 1. It is evident from this that the gas flows in through the port 9 and, via the radial ducts 27, into the vent 23 in the center of the control part 19. Owing to the fact that the shaft 6 runs with a certain clearance in the vent 23, the gas flowing into it produces an air-mounting of the said shaft 6, which means that it is displaceable virtually without friction. The gas then flows either parallel along the shell surface of the shaft 6 and into the chamber 7 or out from the measuring device 1, or through the openings 25 and into the duct 21 in the shaft 6. When the duct 21 is filled with gas, which gas will eventually leave the duct 21 to form the gas cushion between the sensor 8 and the strip 2, a pressure is generated against the plug 32 present in the duct 21 in the direction away from the strip 2. Simultaneous to this, the gas flowing into the chamber 7 will press against the upper portion 6 of the transmitter body 4 and the plug 32. In the absence of the restrictor 10, or in the event of a total closure thereof, the pressure in the chamber 7 will become somewhat higher than the pressure in the duct 21 in the shaft 6, which, in combination with a somewhat larger pressure surface, results in a force resultant acting in the direction of the strip 2 and opposed by the pressure in the gas cushion formed between the strip 2 and the transmitter body 4. The effect is that the gas cushion also exerts a pressure against the strip 2, usually equivalent to a weight of about 320 g/cm², which gives rise to the aforementioned strip deformations. If, on the other hand, the restrictor 10 is set by means of the computer member 12 to admit a certain gas flow, then the pressure locally within the chamber 7 is lowered, producing a reduction in the force resultant acting upon the transmitter body (which force resultant may, in the extreme case, be negative). The effect is that the pressure in the gas cushion, opposing the force resultant, is able to be reduced, which stems from the fact that a part of the gas which previously helped to form the gas cushion now flows out through the restrictor 10. The result is a lowering of the pressure which the gas cushion exerts against the strip 2 to a level equivalent to a weight of about 0-320 g/cm², most advantageously about 0-65 g/cm², at which no perceptible deformations of the strip 2 occur.

The restrictor 10 is advantageously set to a suitable through-flow in advance of the use of the measuring device 1, for example through measurement of the pressure exerted against the strip 2 by the gas cushion. In certain situations, however, it may also be desirable to conduct a regular check on the pressure in the gas cushion to ensure a continuously high quality of the acquired measurement results. To this end, the pressure sensor 38 is mounted in the chamber 7 for continuous measurement of the pressure therein. On the basis of the measurement results acquired by means of the pressure sensor 38, the computer member 12 can then use a predetermined relationship between the gas pressure in the chamber 7 and the gas cushion to calculate the pressure exerted against the strip 2 by the gas cushion and can control the restrictor 10, on the basis thereof, to combat any pressure changes.

The invention is not, of course, limited to the embodiment described above and expert modifications of the measuring device are possible without thereby departing from the scope of the protection as defined by the following independent claims. For example, the restrictor may be placed elsewhere in the measuring device as long as it conducts gas away from the chamber, and more or less than one pressure sensor may be present, either in the chamber or elsewhere in the measuring device. If the restrictor is controlled manually, it is also possible to dispense fully with the computer member and the pressure sensor, in which case the restrictor is set just once prior to measurement, for example by measuring, by means of a wave, a pressure exerted against the latter by the gas cushion (alternatively the pressure sensor can be read manually). Finally, in the above description it is stated that the measuring device is placed above the strip, whereas, in an alternative embodiment, it may be differently mounted, for example below or beside the strip, as long as it extends essentially perpendicular thereto.

1. Measuring device for measuring the thickness of at least one layer of a moving strip, comprising a transmitter body, which is axially movable within a transmitter housing and has a sensor head, designed to rest against the layer via a gas cushion, and an upper portion, extending into a chamber delimited within the transmitter housing, which transmitter housing is provided with at least one port for the supply of gas, which flows, in part, through a longitudinal duct in the transmitter body so as to form the said gas cushion and forms, in part, into the chamber, wherein the transmitter housing is provided with a restrictor for evacuating gas from the chamber and in that at least one pressure sensor is provided for determining the gas pressure in the chamber.

2. Measuring device according to claim 1, wherein the restrictor is manually controllable.

3. Measuring device according to claim 1, wherein it comprises at least one computer member for calculating the pressure, which, via the gas cushion, acts against the layer, on the basis of the pressure in the chamber determined by means of the pressure sensor, and for controlling the restrictor in dependence on the calculated pressure against the layer.

4. Method for measuring the thickness of at least one layer of a moving strip, comprising the step of measuring the thickness of the layer by means of a measuring device comprising a transmitter body, which is axially movable within a transmitter housing and has a sensor head, designed to rest against the layer via a gas cushion, and an upper portion, extending into a chamber delimited within the transmitter housing, which transmitter housing is provided with at least one port for the supply of gas, which flows, in part, through a longitudinal duct in the transmitter body so as to form the said gas cushion and flows, in part, into the chamber, wherein the method further comprises the step that a restrictor, leading to the chamber, for evacuating gas from the chamber, with the aid of at least one pressure sensor designed to determine the gas pressure in the chamber, is adjusted prior to a thickness measurement of the layer in such a way that the gas cushion exerts a pressure against the layer equivalent to a weight of 0-65 g/cm².

5. Method according to claim 4, wherein a computer member automatically and continuously calculates the pressure acting against the layer via the gas cushion, on the basis of a pressure in the chamber determined by means of a pressure sensor, and controls the restrictor in dependence on the calculated pressure against the layer in such a way the gas cushion continuously exerts a pressure against the layer equivalent to a weight of about 0-65 g/cm².
